(19) United States
(12) Patent Application Publication
(10) Pub. No.: US 2021/0144198 A1
(43) Pub. Date: May 13, 2021

(54) TECHNOLOGIES FOR CROSS-LAYER TASK DISTRIBUTION

(71) Applicant: INTEL IP CORPORATION, Santa Clara, CA (US)

(72) Inventors: Zhibin YU, Unterhaching (DE); Biljana BADIC, Munich (DE); Markus D. MUECK, Unterhaching (DE)

(73) Assignee: Intel IP Corporation, Santa Clara, CA (US)

(21) Appl. No.: 16/975,464

(22) PCT Filed: Jun. 29, 2018
(86) PCT No.: PCT/US2018/040297

§ 371 Date: Aug. 25, 2020

(51) Int. Cl. H04L 29/08; H04W 28/02; H04W 28/08; G06F 9/48; G06F 9/50

(52) U.S. Cl. CPC H04L 67/1008; H04W 28/0252; G06F 9/5083; G06F 9/4881; H04W 28/0967

(57) ABSTRACT

Technologies for cross-layer task distribution include a compute device configured to identify pending communication tasks and pending compute tasks, and estimate a processing load of the pending communication tasks. The compute device is further configured to determine a total processing budget of communication processor(s) of the compute device based on computation resources of the communication processor(s) and determine whether excess processing budget is available to process at least one of the pending compute tasks. Additionally, in response to a determination that the excess processing budget is available to process one or more pending compute tasks, the compute device is configured to allocate at least one of the pending compute tasks to be processed by at least one of the communication processors. Other embodiments are described and claimed.

### BACKGROUND

Mobile computing devices, vehicles, appliances, industrial equipment, and other types of Internet-enabled devices are becoming seemingly ubiquitous. Oftentimes, such devices have limited power and compute resources. Accordingly, those devices generally offload certain data such that computational workloads can be performed remotely (e.g., at the edge, at the cloud, etc.). In modern networks, computational resources are typically widespread either over centralized servers (e.g., cloud computing), distributed infrastructure edge/fog nodes (e.g. edge/fog computing), distributed endpoint nodes (e.g. mist computing), or a combination thereof. It should be appreciated that each of the computational resources along each network segment has particular advantages and disadvantages.

For example, compute devices residing in edge and fog networks generally have an advantage in terms of latency (i.e., lower communication latency) over compute devices in the cloud, for example, due to their proximity and capability of direct wireless communication to terminals (e.g., cellular communications between a base station and a mobile endpoint device, device-to-device communications among multiple endpoint devices). However, edge computing typically has the disadvantage of having less computation capability (e.g., due to low performance application processors within the edge, less overall computation capacity, etc.) than centralized servers in the cloud, which employ high performance computing processors and accelerators (e.g., field-programmable gate arrays (FPGAs), neural processing units (NPUs), etc.). As the number of endpoint devices are connected increases, so too does the offload computations to the edge. Accordingly, those compute devices residing in the edge will have to be improved to handle such an increase in computational requests, preferably without introducing latency, costs, etc. However, higher performing processors are typically much more expensive relative to the processors presently employed in the edge compute devices.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for cross-layer task distribution illustrating multiple networks for processing data including an edge network with one or more device edge compute devices and a fog network with one or more fog compute nodes;

FIG. 2 is a simplified block diagram of at least one embodiment of one of the device edge compute devices of the system of FIG. 1;

FIG. 3 is a simplified block diagram of at least one embodiment of one of the device edge compute devices of the system of FIG. 1;

FIGS. 4A and 4B are a simplified flow diagram of at least one embodiment of a method for allocating data compute tasks to a communication processor that may be executed by a device edge compute device of FIGS. 1-3; and

FIG. 5 is a simplified flow diagram of at least one embodiment of a method for interrupting data compute tasks being processed by a communication processor that may be executed by a device edge compute device of FIGS. 1-3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Referring now to FIG. 1, in an illustrative embodiment, a system 100 for cross-layer task distribution includes one or more endpoint computing devices 102 communicatively coupled to a device edge network 104 that includes one or more device edge compute devices 106. The device edge network 104 is illustratively shown as being communicatively coupled to a fog network 110 that includes one or more fog compute nodes 112. The fog network 110 is illustratively shown as being communicatively coupled to a data center 114 and a cloud provider 116. In use, an application running on an endpoint computing device 102 performs certain actions based on the intended use of the application. It should be appreciated that, in some embodiments, the endpoint computing device 102 may not be the optimal device to store or perform the necessary compute operation(s).

For example, this may be attributable to a lack of sufficient compute power, battery power, and/or storage space available on the endpoint computing device 102, a need to leverage additional/externally sourced information, and/or simply that the compute operation(s) are not supported by the platform (i.e., the hardware/software resources) of the endpoint computing device 102. Accordingly, the endpoint computing device 102 may be configured to collect (e.g., via a sensor (not shown) of the endpoint computing device 102), generate, or otherwise obtain data that is to be wirelessly transmitted (e.g., via a network packet) to a remote computing device (e.g., at the device edge network 104, in the fog network 110, housed in a data center 114, managed by a cloud provider 116, or some other remotely located compute/storage device location) for storage and/or computation operations to be performed thereon.

In an illustrative example, the endpoint computing device 102 generates the application related data to be processed (i.e., compute data) and package that compute data in a network packet, which includes at least a portion of the data in a payload of the network packet, and transmits the payload packet to a device edge compute device 106 at the device edge network 104. The endpoint computing device 102 is additionally configured to generate data specifically for communication purposes (i.e., communication data), such as may be used to establish a connection with the device edge compute device 106, package the communication data, and transmit the communication data to the device edge compute device 106.

Depending on the capabilities and available resources of the device edge compute device 106, various computation(s) may be performed on the compute data associated with a received network packet and the result of the computation(s) returned to the endpoint computing device 102 from which the network packet was received or transmitted to another compute device/network segment for additional processing. However, if the capabilities and/or available resources are insufficient to perform the computation(s), or at least a portion of the computations(s), the device edge compute device 106 may forward the network packet to one of the fog compute nodes 112 at an ingress point of the fog network 110. Accordingly, it should be appreciated that, depending on certain conditions, the network packet, or at least a portion thereof, may be processed by more than one device edge compute device 106 and/or more than one fog compute node 112.

As illustratively shown, the illustrative device edge compute device 106 includes a cross-layer task distributor 108, which may be present in some fog compute node(s) 112, depending on the embodiment. In use, the cross-layer task distributor 108 performs dynamic load distribution between communication tasks and compute tasks (i.e., edge computing tasks). Accordingly, unlike present solutions that introduce overhead and latency by splitting computation intensive tasks into multiple computation light sub-tasks and distribute them into multiple device edge compute devices 106, the cross-layer task distributor 108 takes advantage of heterogeneous computational resources within communication processors (i.e., those processors used for physical layer signal processing for wireless communications) as additional computational resources to support edge computing tasks from application layers.

It should be appreciated that intra-component communication is typically much more efficient and faster relative to communication between components. Accordingly, all time, latency, and efficiency critical tasks should be inside a single component in order to minimize the impact of the lower performing communication links between such distinct components. As such, to perform the dynamic load distribution, which is described in further detail below, the cross-layer task distributor 108 is configured to prioritize communication related tasks in the wireless physical layer (i.e., of the Open Systems Interconnection (OSI) model) over edge computing tasks from the application layer (i.e., of the OSI model).

Typically, the device edge compute device 106 is configured to perform data compute operations (i.e., edge computing tasks) using one or more compute processors (see, e.g., the compute processor(s) 202 of FIG. 2) and communication tasks using one or more communication processors (see, e.g., the communication processor(s) 204 of FIG. 2). However, the cross-layer task distributor 108 is configured to determine whether one or more of the communication processors have sufficient capacity (i.e., excess/redundant processing budget), such that at least a portion of the data compute operations can be allocated to one or more of the communication processor(s). In other words, the cross-layer task distributor 108 is configured to treat edge computing tasks as background tasks that are dynamically allocated into communication processors if there is sufficient excess/redundant processing budget of the communication processor(s).

To do so, the cross-layer task distributor 108 is configured to determine the total processing budget of the communication processor(s) and perform a run-time estimate of a processing load of pending communication tasks. The cross-layer task distributor 108 is further configured to compare the estimated processing load with the total processing budget of the communication processor(s) and, in the event the cross-layer task distributor 108 has determined that excess/redundant processing budget has been detected, the edge computing tasks are dynamically allocated into communication processor to be processed. It should be appreciated that the cross-layer task distributor 108 is additionally configured to, in the event that an urgent communication task request has been received, the cross-layer task distributor 108 is configured to interrupt the edge computing tasks from application layers and reallocated the corresponding processing budget of the communication processor(s) to prioritize the pending communication tasks.

As described previously, in some embodiments, at least a portion of the data transmitted to the device edge compute device 106 may be forwarded to other compute and/or storage devices for which compute operation(s) may be executed thereon and/or the longer-term storage thereof may be managed, such as by the data center 114 or the cloud provider 116. Accordingly, it should be appreciated that at least one device edge compute device 106 provides an ingress point to the device edge network 104 and that at least one device edge compute device 106 provides an egress point from the device edge network 104 to the fog network 110. Similarly, it should be appreciated that at least one fog compute node 112 provides an ingress point to the fog network 110 and that at least one fog compute node 112 provides an egress point from the fog network 110.

It should be further appreciated that additional network segments which are not shown may be included, such as a backhaul and/or core network which allow access to the Internet. Additionally, such networks may be embodied as any number of various wired (e.g., Ethernet) and/or wireless networks. Accordingly, it should be appreciated that such networks may include wired and/or wireless communication paths (e.g., the illustrative network segment connecting interconnects of FIG. 1, as well as those not illustratively shown within each network segment) configured to communicatively couple two or more computing devices (e.g., the device edge compute devices 106, the fog compute nodes 112, etc.), which may be embodied as wired interconnects, wireless communication channels, or a combination thereof, depending on the embodiment.

For example, such networks may be embodied as, or otherwise include, a local area network (LAN), a wide area network (WAN), a global network (e.g., the Internet), a wireless local area network (WLAN), a wireless personal area network (WPAN), a cellular network (e.g., Global System for Mobile Communications (GSM), Long-Term Evolution (LTE), 5G, etc.), a telephony network, a digital subscriber line (DSL) network, a cable network, or any combination thereof. As such, it should be appreciated that one or more of the illustrative network segments (i.e., the device edge network 104 and the fog network 110) may be communicatively coupled to any number of additional networked devices, such as additional computers, routers, switches, access points, etc., to facilitate communications among the devices of the system 100.

The endpoint computing device 102 may be embodied as any type of connected device, such as, without limitation, a mobile computing device (e.g., a smartphone, a tablet computer, a laptop computer, a notebook computer, etc.), an Internet of Things (IoT) device (e.g., a wearable device, a smart home device, a smart vehicle, etc.), an embedded device, or any other type of device capable of transmitting network packets into a device edge network 104 (e.g., via the device edge compute device 106). While not illustratively shown, it should be appreciated that, depending on the embodiment, the endpoint computing device 102 may include one or more sensors and/or actuators. For example, the sensor(s) may be include, but are not limited to, a motion sensor, an image sensor, a position sensor, a temperature sensor, a humidity sensor, a power sensor, an environmental sensor, a building management sensor, a building automation sensor, a radar sensor, a vision sensor, or any other type of sensor.

The device edge compute device 106 may be embodied as, without limitation, a gateway, one or more servers (including, e.g., stand-alone server(s), rack-mounted server(s), blade server(s), etc.), a network appliance (e.g., a multi-access edge computing (MEC) appliance), a distributed computing system, or any other combination of compute/storage device(s) capable of performing the functions described herein. In some embodiments, the device edge compute device 106 may form a portion of the European Telecommunications Standards Institute's (ETSI's) Multi-Access Edge Computing (MEC) edge of a mobile network or cellular network (e.g., Global System for Mobile Communications (GSM), Long-Term Evolution (LTE), 5G, etc.). Depending on the embodiment, the device edge compute device 106 may be located in a base station, a small cell, data station, or other carrier/provider device which serves as a gateway between the endpoint computing devices 102 and the fog compute devices 112 of the fog network 110.

Referring now to FIG. 2, an illustrative device edge compute device 106 is shown which includes a compute engine 200, an I/O subsystem 208, one or more data storage devices 210, communication circuitry 212, and, in some embodiments, one or more peripheral devices 214. It should be appreciated that the device edge compute device 106 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component.

The compute engine 200 may be embodied as any type of device or collection of devices capable of performing the various compute functions as described herein. In some embodiments, the compute engine 200 may be embodied as a single device such as an integrated circuit, an embedded system, a field-programmable gate array (FPGA), a system-on-a-chip (SOC), an application specific integrated circuit (ASIC), reconfigurable hardware or hardware circuitry, or other specialized hardware to facilitate performance of the functions described herein. The illustrative compute engine 200 includes, or may otherwise be embodied as, one or more compute processors 202 (i.e., one or more central processing units (CPUs)), one or more communication processors 204, and memory 206.

The compute processor(s) 202 may be embodied as any type of processor capable of performing the functions described herein. For example, the compute processor(s) 202 may be embodied as one or more single-core processors, one or more multi-core processors, a digital signal processor, a microcontroller, or other processor or processing/controlling circuit(s). In some embodiments, the compute processor(s) 202 may be embodied as, include, or otherwise be coupled to an FPGA, an ASIC, reconfigurable hardware or hardware circuitry, or other specialized hardware to facilitate performance of the functions described herein.

The communication processor(s) 204 may be may be embodied as any type of processor capable of performing the functions described herein. Similar to the compute processor(s) 202, the communication processor(s) 204 may be configured as any type of processor or processing/controlling circuitry. However, the communication processor(s) 204 have certain optimizations built inside its hardware and/or software that enables the communication processor(s) 204 to perform communication tasks in an efficient manner. While the compute processor(s) 202 are typically configured to process edge computation workloads more effectively and efficiently than the communication processor(s), relative to the communication processor(s) 204, it should be appreciated that the communication processor(s) 204 should be embodied as any type of processor that is capable of processing edge computation workloads. While illustratively shown as residing in the compute engine 200, one or more of the communication processor(s) 204 may reside in the communication circuitry 212 described below, depending on the embodiment.

The memory 206 may be embodied as any type of volatile or non-volatile memory or data storage capable of performing the functions described herein. It should be appreciated that the memory 206 may include main memory (i.e., a primary memory) and/or cache memory (i.e., memory that can be accessed more quickly than the main memory). Volatile memory may be a storage medium that requires power to maintain the state of data stored by the medium. Non-limiting examples of volatile memory may include various types of random access memory (RAM), such as dynamic random access memory (DRAM) or static random access memory (SRAM).

The compute engine 200 is communicatively coupled to other components of the device edge compute device 106 via the I/O subsystem 208, which may be embodied as circuitry and/or components to facilitate input/output operations with the compute processor(s) 202, the communication processor(s) 204, the memory 206, and other components of the device edge compute device 106. For example, the I/O subsystem 208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 208 may form a portion of a system-on-a-chip (SoC) and be incorporated, along with one or more of the compute processors 202, one or more of the communication processors 204, the memory 206, and/or other components of the device edge compute device 106, on a single integrated circuit chip.

The one or more data storage devices 210 may be embodied as any type of storage device(s) configured for short-term or long-term storage of data, such as, for example, memory devices and circuits, memory cards, hard disk drives, solid-state drives, or other data storage devices. Each data storage device 210 may include a system partition that stores data and firmware code for the data storage device 210. Each data storage device 210 may also include an operating system partition that stores data files and executables for an operating system.

The communication circuitry 212 may be embodied as any communication circuit, device, or collection thereof, capable of enabling communications between the device edge compute device 106 and other computing devices (e.g., the endpoint computing device 102, other device edge compute devices 106, one or more of the fog compute nodes 112, etc.), as well as any network communication enabling devices, such as an access point, network switch/router, etc., to allow communication over the device edge network 104. Accordingly, the communication circuitry 212 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication. It should be appreciated that, in some embodiments, the communication circuitry 212 may include specialized circuitry, hardware, or combination thereof to perform pipeline logic (e.g., hardware algorithms) for performing the functions described herein, including applying the hash functions, processing network packets (e.g., parse received network packets, determine destination computing devices for each received network packets, forward the network packets to a particular buffer queue of a respective host buffer of the device edge compute device 106, etc.), performing computational functions, etc.

In some embodiments, performance of one or more of the functions of communication circuitry 212 as described herein may be performed by specialized circuitry, hardware, or combination thereof of the communication circuitry 212, which may be embodied as a system-on-a-chip (SoC) or otherwise form a portion of a SoC of the device edge compute device 106 (e.g., incorporated on a single integrated circuit chip along with one or more of the compute processor(s) 202, one or more of the communication processor(s) 204, the memory 206, and/or other components of the device edge compute device 106). Alternatively, in some embodiments, the specialized circuitry, hardware, or combination thereof may be embodied as one or more discrete processing units of the device edge compute device 106, each of which may be capable of performing one or more of the functions described herein. It should be appreciated that, in some embodiments, one or more of the communication processor(s) 204 may reside in the communication circuitry 212.

The communications circuitry 210 may use any of the radio links described herein and may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), etc.

It should be appreciated that aspects described herein can be used in the context of any spectrum management scheme including dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively.

Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Similarly, it should be appreciated that aspects described herein can also implement a hierarchical application of the scheme is possible, e.g. by introducing a hierarchical prioritization of usage for different types of users (e.g., low/medium/high priority, etc.), based on a prioritized access to the spectrum e.g. with highest priority to tier-1 users, followed by tier-2, then tier-3, etc. users, etc. It should be further appreciated that aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources. Some of the features in this document are defined for the network side, such as access points, eNodeBs, New Radio (NR) or next generation Node Bs (gNodeB or gNB—note that this term is typically used in the context of 3GPP fifth generation (5G) communication systems), etc. Still, in some embodiments, user equipment (UE) may take this role as well and act as an access point, eNodeB, gNodeB, etc. In other words, some or all features defined for network equipment may be implemented by a UE.

The one or more peripheral devices 214 may include any type of device that is usable to input information into the device edge compute device 106 and/or receive information from the device edge compute device 106. The peripheral devices 214 may be embodied as any auxiliary device usable to input information into the device edge compute device 106, such as a keyboard, a mouse, a microphone, a barcode reader, an image scanner, etc., or output information from the device edge compute device 106, such as a display, a speaker, graphics circuitry, a printer, a projector, etc. It should be appreciated that, in some embodiments, one or more of the peripheral devices 214 may function as both an input device and an output device (e.g., a touchscreen display, a digitizer on top of a display screen, etc.). It should be further appreciated that the types of peripheral devices 214 connected to the device edge compute device 106 may depend on, for example, the type and/or intended use of the device edge compute device 106. Additionally or alternatively, in some embodiments, the peripheral devices 214 may include one or more ports, such as a USB port, for example, for connecting external peripheral devices to the device edge compute device 106.

Referring back to FIG. 1, each of the fog compute nodes 112 may be embodied as any type of computing node capable of providing resources for fog computing/services (e.g., in a fog network 110), such as a server (e.g., stand-alone, rack-mounted, blade, etc.), a sled (e.g., a compute sled, an accelerator sled, a storage sled, a memory sled, etc.), an enhanced network interface controller (NIC) (e.g., a HFI), a network appliance (e.g., physical or virtual), a router, switch (e.g., a disaggregated switch, a rack-mounted switch, a standalone switch, a fully managed switch, a partially managed switch, a full-duplex switch, and/or a half-duplex communication mode enabled switch), a wireless access point, a web appliance, a distributed computing system, an accelerator-based system, a processor-based system, and/or a multiprocessor system capable of performing the functions described herein.

It should be appreciated that, in some embodiments, the device edge compute device 106 may itself be considered a fog compute node 112 and/or form a portion of a fog network 110 (e.g., an entry point thereof), depending on the implementation and function associated therewith. Accordingly, it should be further appreciated that the fog compute nodes 112 may include similar and/or like components to those of the illustrative device edge compute device 106 of FIG. 2, such as a compute engine (e.g., with one or more compute processors, one or more communication processors, and memory), an I/O subsystem, one or more data storage devices, communication circuitry, etc. As such, figures and descriptions of the similar/like components are not repeated herein for clarity of the description with the understanding that the description of the corresponding components provided above in regard to the illustrative device edge compute device 106 of FIG. 2 applies equally to the corresponding components of the fog compute nodes 112. Of course, it should be appreciated that the respective computing devices may include additional and/or alternative components, depending on the embodiment. Furthermore, as illustratively shown in FIG. 1, in some embodiments, the fog compute nodes 112 may include the cross-layer task distributor 108.

Referring now to FIG. 3, in an illustrative embodiment, one of the device edge compute devices 106 establishes an environment 300 during operation. The illustrative environment 300 includes the cross-layer task distributor 108 of FIG. 1, as well as a network traffic ingress/egress manager 308 and a task scheduler 310. The various components of the environment 300 may be embodied as hardware, firmware, software, or a combination thereof. As such, in some embodiments, one or more of the components of the environment 300 may be embodied as circuitry or collection of electrical devices (e.g., network traffic ingress/egress management circuitry 308, task scheduler circuitry 310, cross-layer task distribution circuitry 108, etc.).

It should be appreciated that, in such embodiments, one or more of the network traffic ingress/egress management circuitry 308, the task scheduler circuitry 310, and the cross-layer task distribution circuitry 108 may form a portion of one or more of the compute engine (i.e., the compute processor(s) 202, the communication processor(s) 204, and/or the memory 206), the I/O subsystem 208, the data storage device(s) 210, the communication circuitry 212, an application specific integrated circuit (ASIC), a programmable circuit such as a field-programmable gate array (FPGA), and/or other components of the device edge compute device 106.

For example, any of the circuitry (e.g., the network traffic ingress/egress management circuitry 308, the task scheduler circuitry 310, the cross-layer task distribution circuitry 108, etc.) may be embodied as at least a portion of the compute engine 200 and associated instructions stored in the memory 206 and/or the data storage device(s) 210, which may be executed by the compute processor(s) 202 and/or the communication processor(s) 204. Accordingly, it should be appreciated that, each of the functions described herein as being performed by the network traffic ingress/egress management circuitry 308, the task scheduler circuitry 310, and/or the cross-layer task distribution circuitry 108 may be performed, at least in part, by one or more components of the device edge compute device 106, such as the compute engine 200, the I/O subsystem 208, the communication circuitry 212, and/or other components of the device edge compute device 106.

Additionally, in some embodiments, one or more of the illustrative components may form a portion of another component and/or one or more of the illustrative components may be independent of one another. Further, in some embodiments, one or more of the components of the environment 300 may be embodied as virtualized hardware components or emulated architecture, which may be established and maintained by the compute engine 200 or other components of the device edge compute device 106. It should be appreciated that the device edge compute device 106 may include other components, sub-components, modules, sub-modules, logic, sub-logic, and/or devices commonly found in a computing device, which are not illustrated in FIG. 3 for clarity of the description.

In the illustrative environment 300, the device edge compute device 106 additionally includes pending task data 302, computation resource data 304, and task schedule data 306, each of which may be accessed by the various components and/or sub-components of the device edge compute device 106. Additionally, it should be appreciated that in some embodiments the data stored in, or otherwise represented by, each of the pending task data 302, the computation resource data 304, and the task schedule data 306 may not be mutually exclusive relative to each other. For example, in some implementations, data stored in the pending task data 302 may also be stored as a portion of one or more of the computation resource data 304 and/or the task schedule data 306. As such, although the various data utilized by the device edge compute device 106 is described herein as particular discrete data, such data may be combined, aggregated, and/or otherwise form portions of a single or multiple data sets, including duplicative copies, in other embodiments.

The network traffic ingress/egress manager 308, which may be embodied as hardware, firmware, software, virtualized hardware, emulated architecture, and/or a combination thereof as discussed above, is configured to receive inbound and route/transmit outbound network traffic. To do so, the network traffic ingress/egress manager 308 is configured to facilitate inbound/outbound network communications (e.g., network traffic, network packets, fog frames, etc.) to and from the device edge compute device 106. For example, the network traffic ingress/egress manager 308 is configured to manage (e.g., create, modify, delete, etc.) connections to physical and virtual network ports (i.e., virtual network interfaces) of the device edge compute device 106 (e.g., via the communication circuitry 212), as well as the ingress/egress buffers/queues associated therewith. Additionally, the network traffic ingress/egress manager 308 is configured to implement explicit per-packet routing decision logic for fine-grained control and policies, such as may be enforced within the fog network segment of the device edge network 104 in which the device edge compute device 106 is deployed. The network traffic ingress/egress manager 308 is further configured to manage a communication data rate which controls the rate at which communication data is received (e.g., adjust lower to free additional communication processor computation resources for processing compute tasks or adjust higher to use communication processor computation resources for processing communication tasks).

The task scheduler 310, which may be embodied as hardware, firmware, software, virtualized hardware, emulated architecture, and/or a combination thereof as discussed above, is configured to schedule tasks (i.e., compute tasks, communication tasks, etc.) to the appropriate compute processor 202 or the appropriate communication processor 204. To do so, the illustrative task scheduler 310 includes a communication task identifier 312, a compute task identifier 314, and a task distributor 316. The communication task identifier 312 is configured to identify communication tasks (e.g., in the physical layer). The compute task identifier 314 is configured to identify compute tasks (e.g., at the application layer). In some embodiments, the identified communication tasks and/or compute tasks, or information related thereto, may be stored in the pending task data 302.

The task distributor 316 is configured to distribute the identified communication tasks to a communication processor (i.e., one of the communication processors 204 of FIG. 2), such as by inserting the communication tasks into a work/task queue associated with the applicable communication processor 204 to which the communication tasks are to be assigned. Similarly, the task distributor 316 is additionally configured to distribute the identified compute tasks to an a compute processor (i.e., one of the compute processors 202 of FIG. 2), such as by inserting the compute tasks into a work/task queue associated with the applicable compute processor 202 to which the communication tasks are to be assigned.

However, under certain conditions as described herein, at least a portion of the identified compute tasks may be assigned or otherwise allocated to one or more communication processors 204, depending on the compute availability thereof (e.g., such as may be determined by the cross-layer task distributor 108). Accordingly, under such conditions, the task distributor 316 is configured to distribute the assigned/allocated compute tasks to a communication processor 204. In some embodiments, the assigned/allocated compute tasks and any schedule information associated therewith may be stored in the task schedule data 306.

As described previously, intra-component communication is typically much more efficient and faster relative to communication between components. Accordingly, each application is split into tasks. It should be appreciated that the required efficiency of the communication links between tasks is determined and classified (e.g., Megabits-per-second (in average/peak), required maximum latency, etc.). To do so, the task distributor 316 is configured to distribute those compute tasks with a high classification (i.e., high required efficiency) to a single component (e.g., a compute processor 202). Additionally, the task distributor 316 is configured to distribute other compute tasks with the same or lower classification (i.e., with strong linkage to the higher classified component which was first put into the concerned component) to that same component until the capacity limit is reached.

The task distributor 316 is configured to similarly place the other high classification tasks to that same component. However, the task distributor 316 is configured to distribute those tasks which do not have a strong linkage (i.e., communication requirements) to other high classification tasks which were already put into other components into different components (e.g., a communication processor 204). In other words, since the tasks are not strongly linked (i.e., no high throughput exchange is required) there is no loss in efficiency when such weakly linked tasks are put into different components and can therefore be placed into different components. Additionally, task distributor 316 is configured to distribute other tasks with the same or lower classification (i.e., with strong linkage to the highly classified component that was first put into the single component) to that component until the capacity limit is reached.

Alternatively, the task distributor 316 may be configured to distribute tasks based on their role in a specific layer of the OSI layer model. In other words, any task is assumed to belong to a single layer of the OSI layer model. It should be appreciated that an inference is made that the communication efficiency is likely to be high among all tasks within a given layer, but a lower efficiency can be tolerated for tasks between different layers. Accordingly, the task distributor 316 is configured to allocate tasks within a given layer to a single component—or (if such a single component does not have the required efficiency) split the allocation of the tasks over components which have efficient and high performance interconnection solutions. It should be appreciated that tasks of different layers can be allocated to other components and a less performing interconnection between the layers can typically be tolerated.

The cross-layer task distributor 108, which may be embodied as hardware, firmware, software, virtualized hardware, emulated architecture, and/or a combination thereof as discussed above, is configured to determine whether one or more compute tasks are to be allocated to one or more communication processors 204 and manage the dynamic load distribution of the compute tasks to the one or more communication processors 204 (e.g., via the task distributor 316). To manage the dynamic load distribution of the compute tasks, the illustrative cross-layer task distributor 108 includes a run-time processing load estimator 320, a processing budget determiner 322, and a processing budget analyzer 324.

The run-time processing load estimator 320 is configured to estimate the processing load of pending communication tasks by based on the quality of wireless channel conditions. To estimate the processing load of pending communication tasks, the run-time processing load estimator 320 is configured to identify pending communication tasks (e.g., as identified by the communication task identifier 312) and estimate an amount of workload that may be required to process all of the identified pending communication tasks. To determine the quality of wireless channel conditions, the run-time processing load estimator 320 is configured to monitor wireless communication modes and measure wireless channel conditions at run-time. For example, the monitored wireless communication modes may include any information related to a communication mode, such as allocated/supported communication bandwidth, the number of MIMO layers, a connection status (e.g., idle, connected, active, etc.), gap-based reception support, etc. The measured wireless channel conditions may include any measured conditions related to a wireless communication channel, such as an interference level, high mobility, low mobility, etc.

The processing budget determiner 322 is configured to determine a total processing budget of the communication processor(s) 204. To do so, the processing budget determiner 322 is configured to determine an available processing budget for each of the communication processor(s) 204 and calculate a sum thereof to determine the total processing budget of the communication processor(s) 204. In some embodiments, the available processing budget and/or any other computation resource related data may be stored in the computation resource data.

The processing budget analyzer 324 is configured to determine whether to dynamically distribute at least a portion of the load of compute tasks to the one or more communication processors 204. To do so, the processing budget analyzer 324 is configured to compare the estimated processing load (e.g., as determined by the run-time processing load estimator 320) with the determined processing budget (e.g., as determined by the processing budget determiner 322) to determine whether there is excess/redundant processing budget, such that the edge computing tasks can be dynamically allocated (e.g., by the task distributor 316) into a communication processor 204 to be processed.

It should be appreciated that, based on the quality of wireless channel conditions, complex demodulation algorithms may be activated by the device edge compute device 106 in case of bad channel conditions (e.g., low signal to noise ratio (SNR), high mobility, etc.). As such, higher computation loads are typically required by the communication tasks. In turn, under such conditions, less edge computing tasks can be allocated to the communication processors 204. However, in the case of good channel conditions (e.g., high SNR, low mobility, etc.), simple demodulation algorithms may be activated by the device edge compute device 106. As such, lower computation loads are typically required by the communication tasks. Accordingly, under such conditions, more computation budget can serve edge-computing tasks from the application layer.

In some embodiments, the processing budget analyzer 324 may be further configured to analyze computational resources from across other compute device across the other network segments (e.g., the mist network (not shown) that includes the endpoint device(s) 102, the device edge network 104 that includes the device edge compute device(s) 106, the fog network 110 that includes the fog compute nodes 112, the compute devices (not shown) of the data center 114 and/or cloud provider 116, etc.) and map the needs per layer (of the OSI model) onto the available compute resources. For some layers of the OSI model, all of the compute devices of the network segments may be suitable, in particular if a multitude of independent tasks exist which do require a minimum of interaction, and for some other layers only a subset or none of the compute devices of the network segments may be suitable, in particular if there are intense interactions between distributed tasks that are preferably executed in a single geographical location.

Referring now to FIGS. 4A and 4B, a method 400 for allocating data compute tasks to a communication processor is shown which may be executed by one of the device edge compute devices 106 of FIG. 1 (e.g., by the network traffic ingress/egress management circuitry 308, the task scheduler circuitry 310, and/or the cross-layer task distribution circuitry 108). The method 400 begins with block 402, in which the device edge compute device 106 determines whether to distribute compute tasks (i.e., to one or more of the communication processors 204). It should be appreciated that the method 400 may be triggered under certain triggering conditions, such as a maximum or minimum compute threshold having been reached, a detected change in a network segment or communication channels therein, a compute device (e.g., another device edge compute device 106, a fog compute node 112, etc.) having been connected or disconnected, an endpoint computing device 102 having been connected or disconnected, etc.

If the device edge compute device 106 determines the compute tasks are to be distributed, the method 400 advances to block 404, in which the device edge compute device 106 identifies any pending communication tasks and pending compute tasks (i.e., of the application for which the pending tasks are associated). To do so, in block 406, the device edge compute device 106 determines a required efficiency of the communication links between the pending tasks. Additionally, in some embodiments, in block 408, the device edge compute device 106 classifies each of the pending tasks based on a communication requirement between the pending tasks.

For example, as described previously, the device edge compute device 106 may be configured to identify the pending compute tasks as those pending tasks having a high required efficiency. As also described previously, the device edge compute device 106 may be configured to determine which of the remaining compute tasks have a strong linkage (i.e., a higher communication requirement) or a weak linkage (a low/no communication requirement), and identify those pending tasks as compute tasks that can be processed by the communication processors 204. Alternatively, in other embodiments, in block 410 the device edge compute device 106 may classify each of the pending tasks based on a corresponding level of the OSI model. In such embodiments, the device edge compute device 106 may classify pending tasks in the physical layer of the OSI model as pending communication tasks and the pending tasks in the application layer of the OSI model as pending compute tasks.

In block 412, the device edge compute device 106 estimates a processing load of the identified communication tasks. To estimate the processing load of the identified communication tasks, in block 414, the device edge compute device 106 identifies the wireless communication modes monitored in run-time. As described previously, the wireless communication modes may include any information related to a communication mode, such as communication bandwidth, the number of MIMO layers, a connection status (e.g., idle, connected, active, etc.), gap-based reception support, etc. Additionally, to estimate the processing load of the identified communication tasks, in block 416, the device edge compute device 106 identifies condition quality levels of the wireless channels in run-time. As described previously, the wireless channel condition quality levels may include any measured condition quality levels related to a wireless communication channel, such as a level of interference, high mobility, low mobility, etc.

In block 418, the device edge compute device 106 determines computation resources for each of the one or more communication processors 204 of the device edge compute device 106. In block 420, the device edge compute device 106 determines a total processing budget of the communication processor(s) 204 based on the determined communication processor computation resources. In block 422 of FIG. 4B, the device edge compute device 106 compares the estimated processing load of the identified communication tasks with the determined total processing budget. In block 424, the device edge compute device 106 determines whether there is excess processing budget available as a result of the comparison. In some embodiments, the excess processing budget may be determined based on whether the total processing budget of the communication processor(s) is greater than the estimated processing load (i.e., indicating that there is any excess processing budget. In other embodiments, the excess processing budget available may be determined based on a threshold amount, such as may be indicated by an amount of computation budget, a percentage of total processing budget available relative to the total processing budget, etc.

If the device edge compute device 106 determines there is not excess or that there is otherwise an insufficient amount of excess processing budget available (e.g., based on an required excess threshold) relative to the estimated processing load, the method 400 returns to block 402; otherwise, the method 400 advances to block 426. In block 426, the device edge compute device 106 identifies a priority level one or more communication quality of service (QoS) levels. The communication QoS levels may be any type of any type of network and/or resource (e.g., physical or virtual compute, memory, power, etc.) applicable service level required to be met by the device edge compute device 106, including, for example, communication data rate, communication latency, etc. The communication QoS priority levels may be determined based on communication QoS priority levels set in a service level agreement (SLA) or other set of network policies/rules. In block 428, the device edge compute device 106 compares the identified priority levels of the one or more communication QoS level requirements to priority levels of the identified pending compute tasks.

In block 430, the device edge compute device 106 determines whether the identified communication QoS priority level(s) are lower than the priority level(s) of the identified pending compute tasks priority levels (i.e., as a result of the comparison). In some embodiments, the device edge compute device 106 may be configured to identify the priority of a compute task by its maximal processing latency requirement and/or the additional power consumption penalty if an application layer compute task is executed within a communication processor rather than in a compute processor (i.e., at the application layer). It should be appreciated that the higher consumption power penalty, the lower priority. Additionally or alternatively, the device edge compute device 106 may be configured to determine the compute task priority by category of the computation, such as safety related computations (e.g., user authentication), entertainment related computations (e.g., camera imagine enhancement), etc.

If the device edge compute device 106 determines the identified communication QoS priority level(s) are lower than the priority level(s) of the identified pending compute tasks priority levels, the method 400 branches to block 434. In block 434, the device edge compute device 106 reduces the communication level(s) to free additional communication processor computation resources. It should be appreciated that the device edge compute device 106 is configured to only reduce the communication level(s) to a sufficient level that still meets or exceeds any applicable communication QoS priority level requirements (e.g., such as may be set in the SLA or other network/policy rules).

For example, the device edge compute device 106 may reduce a communication data rate level (i.e., to reduce the speed of communication messages), an acceptable communication latency level (i.e., to allow for more latency), etc. It should be appreciated that when communication data processing tasks and edge computing tasks are sharing the computation resource within communication processors (i.e., instead of purely prioritizing processor resources for real-time communication data processing tasks) the device edge compute device 106 may be configured to jointly consider the cost of the communication data rate and the cost of compute processing time, such that the overall user experience of the compute task (i.e., at the device edge network 104 and/or the fog network 110 of FIG. 1) can be optimized.

In an illustrative example, an image processing task has been offloaded to a remote edge from an endpoint device (e.g., one of the endpoint computing devices 102 of FIG. 1), the total latency is the sum of the communication latency associated with sending the task to the remote edge, and the actual image processing time at the remote edge. Accordingly, when image processing time is more dominating than the communication latency, the communication data rate can be reduced (e.g., to change the communication mode with low data rate by reducing the data bandwidth or by reduced number of MIMO layers, etc.), such that more computation budget in the communication processors 204 at the edge can be used to speed up the edge compute task (e.g., the image processing in the illustrative example). As such, the total latency can be reduced for a better user experience.

Referring back to block 430, if the device edge compute device 106 determines that the identified communication QoS priority level(s) are not lower than the priority level(s) of the identified pending compute tasks priority levels, the method branches to block 432. In block 432, the device edge compute device 106 dynamically allocates at least a portion of the identified pending compute tasks into a task queue of at least one communication processor 204. In some embodiments, the device edge compute device 106 may assign a higher level priority to the received pending compute tasks relative to the identified pending communication tasks.

It should be appreciated that, while the distribution of compute tasks to the communication processor(s) 204 has been described herein as being distributed to only those communication processor(s) 204 of a single device edge compute device 106, compute tasks may be distributed across more than one compute device (i.e., more than one device edge compute device 106, more than one fog compute node 112, etc.) which may be in the same and/or across multiple network segments (i.e., one or more device edge networks 104, one or more fog networks 110). Accordingly, in such embodiments, the device edge compute device 106 may be additionally configured to determine available computation resources across those compute devices. Further, in such embodiments, such compute task distribution should be optimized to minimize communication latency and bandwidth (e.g., minimize signaling between geographically separated components), while efficiently utilizing the distributed computational capabilities.

Referring now to FIG. 5, a method 500 for interrupting data compute tasks being processed by a communication processor is shown which may be executed by one of the device edge compute devices 106 of FIG. 1 (e.g., by the network traffic ingress/egress management circuitry 308, the task scheduler circuitry 310, and/or the cross-layer task distribution circuitry 108). The method 500 begins with block 502, in which the device edge compute device 106 determines whether an urgent data communication task has been received. If so, the method 500 branches to block 504, in which the device edge compute device 106 interrupts any presently executing compute tasks from application layer(s). In block 506, the device edge compute device 106 reallocates the communication processor processing budget to prioritize pending communication tasks relative to pending compute tasks. In block 508, the device edge compute device 106 processes the received urgent communication task, as well as any other communication tasks. In some embodiments, the device edge compute device 106 may trigger the method 400 to be executed upon completion of processing the received urgent communication task.

Referring back to block 502, if the device edge compute device 106 determines whether that no communication task has been received that should be prioritized over the compute tasks, the method 500 branches to block 510. In block 510, the device edge compute device 106 continues processing the allocated compute tasks (i.e., those pending compute tasks having a higher priority than the pending communication tasks) in the task queue of the communication processor 204. In block 512, the device edge compute device 106 determines whether processing of the allocated compute tasks has completed. If not, the method 500 returns to block 502 to again determine whether an urgent communication task has been received; otherwise, if processing of the allocated compute tasks has completed, the method 500 proceeds to block 506 in which, as described previously, the device edge compute device 106 reallocates the communication processor processing budget to prioritize pending communication tasks relative to pending compute tasks.

While the method 400 and 500 have been illustratively shown as being executed by the device edge compute device 106, it should be appreciated that, in some embodiments, the method 400 and 500 may be performed, at least in part, by one or more of the fog compute nodes 112 of the fog network 110. In other words, in some embodiments, the network traffic ingress/egress management circuitry 308, the task scheduler circuitry 310, and/or the cross-layer task distribution circuitry 108 may reside in the one or more of the fog compute nodes 112.

### EXAMPLES

Illustrative examples of the technologies disclosed herein are provided below. An embodiment of the technologies may include any one or more, and any combination of, the examples described below.

Example 1 includes a compute device for cross-layer task distribution, the compute device comprising one or more communication processors; one or more compute processors; task scheduling circuitry to identify one or more pending communication tasks and one or more pending compute tasks; and cross-layer task distribution circuitry to estimate a processing load of the identified one or more communication tasks; determine a total processing budget of the one or more communication processors based on computation resources of the one or more communication processors; determine whether excess processing budget is available to process at least one of the one or more pending compute tasks; and allocate, in response to a determination that the excess processing budget is available to process one or more pending compute tasks, at least one of the one or more pending compute tasks to be processed by at least one of the one or more communication processors.

Example 2 includes the subject matter of Example 1, and wherein to determine whether the excess processing budget is available to process the at least one of the one or more pending compute tasks comprises to compare the estimated processing load and determine whether the total processing budget is greater than the estimated processing load.

Example 3 includes the subject matter of any of Examples 1 and 2, and wherein to determine whether the total processing budget is greater than the estimated processing load comprises to determine whether the total processing budget is greater than the estimated processing load by a threshold amount.

Example 4 includes the subject matter of any of Examples 1-3, and wherein the threshold amount is determined based on an estimated amount of computation resources required to process the at least one of the one or more pending compute tasks.

Example 5 includes the subject matter of any of Examples 1-4, and wherein to allocate the at least one of the one or more pending compute tasks comprises to one of (a) assign a priority level to the at least one of the one or more pending compute tasks that is greater than communication tasks being processed by the one or more communication processors or (b) enqueue the at least one of the one or more pending compute tasks into a task queue of the one or more communication processors.

Example 6 includes the subject matter of any of Examples 1-5, and wherein the cross-layer task distribution circuitry is further to (i) identify, in response to the determination that the excess processing budget is available to process the one or more pending compute tasks, a priority level of one or more communication quality of service requirements and (ii) compare the identified priority level of the one or more communication quality of service requirements against a priority level of the one or more pending compute tasks; and further comprising network traffic ingress/egress management circuitry to reduce, in response to a determination that a result of the comparison indicates that the identified priority level of the one or more communication quality of service requirements is lower than a priority level of the one or more pending compute tasks, a communication data rate to free additional communication processor computation resources for processing the at least one of the one or more pending compute tasks.

Example 7 includes the subject matter of any of Examples 1-6, and wherein the one or more communication quality of service requirements includes at least one of a communication data rate requirement and a communication latency requirement.

Example 8 includes the subject matter of any of Examples 1-7, and wherein the cross-layer task distribution circuitry is further to monitor wireless communication modes at run-time, and wherein to estimate the processing load comprise to estimate the processing load as a function of the monitored wireless communication modes.

Example 9 includes the subject matter of any of Examples 1-8, and wherein the cross-layer task distribution circuitry is further to measure wireless channel conditions at run-time, and wherein to estimate the processing load comprise to estimate the processing load as a function of the measured wireless channel conditions.

Example 10 includes the subject matter of any of Examples 1-9, and wherein the cross-layer task distribution circuitry is further to receive an urgent communication task for processing by the one or more communication processors; interrupt the processing of the at least one of the one or more compute tasks by the one or more communication processors; and reallocate the at least one of the one or more compute tasks to be processed by at least one of the compute processors.

Example 11 includes the subject matter of any of Examples 1-10, and wherein to reallocate the at least one of the one or more compute tasks comprises to assign a priority level to the at least one of the one or more compute tasks that is less than communication tasks being processed by the one or more communication processors.

Example 12 includes the subject matter of any of Examples 1-11, and wherein to identify the communication tasks comprises to identify the communication tasks in a physical layer of the Open Systems Interconnection (OSI) model and wherein to identify the one or more pending compute tasks comprises to identify the one or more pending compute tasks at an application layer of the Open Systems Interconnection (OSI) model.

Example 13 includes a method for cross-layer task distribution, the method comprising identifying, by a compute device, one or more pending communication tasks and one or more pending compute tasks; estimating, by the compute device, a processing load of the identified one or more communication tasks; determining, by the compute device, a total processing budget of one or more communication processors of the compute device based on computation resources of the one or more communication processors; determining, by the compute device, whether excess processing budget is available to process at least one of the one or more pending compute tasks; and allocating, by the compute device and in response to a determination that the excess processing budget is available to process one or more pending compute tasks, at least one of the one or more pending compute tasks to be processed by at least one of the one or more communication processors.

14. The method of claim 13, determining whether the excess processing budget is available to process the at least one of the one or more pending compute tasks comprises comparing the estimated processing load and determine whether the total processing budget is greater than the estimated processing load.

Example 15 includes the subject matter of any of Examples 13 and 14, and wherein determining whether the total processing budget is greater than the estimated processing load comprises determining whether the total processing budget is greater than the estimated processing load by a threshold amount.

Example 16 includes the subject matter of any of Examples 13-15, and further including determining, by the compute device, the threshold amount based on an estimated amount of computation resources required to process the at least one of the one or more pending compute tasks.

Example 17 includes the subject matter of any of Examples 13-16, and wherein allocating the at least one of the one or more pending compute tasks comprises to one of (a) assigning a priority level to the at least one of the one or more pending compute tasks that is greater than communication tasks being processed by the one or more communication processors or (b) enqueuing the at least one of the one or more pending compute tasks into a task queue of the one or more communication processors.

Example 18 includes the subject matter of any of Examples 13-17, and further including identifying, by the compute device and in response to the determination that the excess processing budget is available to process the one or more pending compute tasks, a priority level of one or more communication quality of service requirements comparing, by the compute device, the identified priority level of the one or more communication quality of service requirements against a priority level of the one or more pending compute tasks; and reducing, by the compute device and in response to a determination that a result of the comparison indicates that the identified priority level of the one or more communication quality of service requirements is lower than a priority level of the one or more pending compute tasks, a communication data rate to free additional communication processor computation resources for processing the at least one of the one or more pending compute tasks.

Example 19 includes the subject matter of any of Examples 13-18, and further including determining, by the compute device, the one or more communication quality of service requirements based on at least one of a communication data rate requirement and a communication latency requirement.

Example 20 includes the subject matter of any of Examples 13-19, and further including monitoring, by the compute device, wireless communication modes at run-time, and wherein estimating the processing load comprise to estimate the processing load as a function of the monitored wireless communication modes.

Example 21 includes the subject matter of any of Examples 13-20, and further including measuring, by the compute device, wireless channel conditions at run-time, and wherein to estimate the processing load comprise to estimate the processing load as a function of the measured wireless channel conditions.

Example 22 includes the subject matter of any of Examples 13-21, and further including receiving, by the compute device, an urgent communication task for processing by the one or more communication processors; interrupting, by the compute device, the processing of the at least one of the one or more compute tasks by the one or more communication processors; and reallocate the at least one of the one or more compute tasks to be processed by one or more compute processors of the compute device.

Example 23 includes the subject matter of any of Examples 13-22, and wherein reallocating the at least one of the one or more compute tasks comprises assigning a priority level to the at least one of the one or more compute tasks that is less than communication tasks being processed by the one or more communication processors.

Example 24 includes one or more machine-readable storage media comprising a plurality of instructions stored thereon that, in response to being executed, cause a compute device to perform the method of any of Examples 13-23.

Example 25 includes a compute device comprising means for performing the method of any of Examples 13-23.

1-25. (canceled)

26. A compute device for cross-layer task distribution, the compute device comprising:
one or more communication processors;
one or more compute processors;
task scheduling circuitry to identify one or more pending communication tasks and one or more pending compute tasks; and
cross-layer task distribution circuitry to:
estimate a processing load of the identified one or more communication tasks;
determine a total processing budget of the one or more communication processors based on computation resources of the one or more communication processors;
determine whether excess processing budget is available to process at least one of the one or more pending compute tasks; and
allocate, in response to a determination that the excess processing budget is available to process one or more pending compute tasks, at least one of the one or more pending compute tasks to be processed by at least one of the one or more communication processors.

27. The compute device of claim 26, wherein to determine whether the excess processing budget is available to process the at least one of the one or more pending compute tasks comprises to compare the estimated processing load and determine whether the total processing budget is greater than the estimated processing load by a threshold amount, wherein the threshold amount is determined based on an estimated amount of computation resources required to process the at least one of the one or more pending compute tasks.

28. The compute device of claim 26, wherein to allocate the at least one of the one or more pending compute tasks comprises to one of (a) assign a priority level to the at least one of the one or more pending compute tasks that is greater than communication tasks being processed by the one or more communication processors or (b) enqueue the at least one of the one or more pending compute tasks into a task queue of the one or more communication processors.

29. The compute device of claim 26, wherein the cross-layer task distribution circuitry is further to (i) identify, in response to the determination that the excess processing budget is available to process the one or more pending compute tasks, a priority level of one or more communication quality of service requirements and (ii) compare the identified priority level of the one or more communication quality of service requirements against a priority level of the one or more pending compute tasks; and
further comprising network traffic ingress/egress management circuitry to reduce, in response to a determination that a result of the comparison indicates that the identified priority level of the one or more communication quality of service requirements is lower than a priority level of the one or more pending compute tasks, a communication data rate to free additional communication processor computation resources for processing the at least one of the one or more pending compute tasks.

30. The compute device of claim 26, wherein the cross-layer task distribution circuitry is further to monitor wireless communication modes at run-time, and wherein to estimate the processing load comprise to estimate the processing load as a function of the monitored wireless communication modes.

31. The compute device of claim 26, wherein the cross-layer task distribution circuitry is further to measure wireless channel conditions at run-time, and wherein to estimate the processing load comprise to estimate the processing load as a function of the measured wireless channel conditions.

32. The compute device of claim 26, wherein the cross-layer task distribution circuitry is further to:
receive an urgent communication task for processing by the one or more communication processors;
interrupt the processing of the at least one of the one or more compute tasks by the one or more communication processors; and
reallocate the at least one of the one or more compute tasks to be processed by at least one of the compute processors.

33. The compute device of claim 32, wherein to reallocate the at least one of the one or more compute tasks comprises to assign a priority level to the at least one of the one or more compute tasks that is less than communication tasks being processed by the one or more communication processors.

34. The compute device of claim 26, wherein the task scheduling circuitry is further to (i) identify a plurality of tasks and (ii) identify which layer of the Open Systems Interconnection (OSI) model each pending task corresponds, wherein to identify the one or more pending communication tasks comprises to identify the communication tasks in a physical layer of the OSI model, and wherein to identify the one or more pending compute tasks comprises to identify the one or more pending compute tasks at an application layer of the OSI model.

35. A method for cross-layer task distribution, the method comprising:
identifying, by a compute device, one or more pending communication tasks and one or more pending compute tasks;
estimating, by the compute device, a processing load of the identified one or more communication tasks;
determining, by the compute device, a total processing budget of one or more communication processors of the compute device based on computation resources of the one or more communication processors;
determining, by the compute device, whether excess processing budget is available to process at least one of the one or more pending compute tasks; and
allocating, by the compute device and in response to a determination that the excess processing budget is available to process one or more pending compute tasks, at least one of the one or more pending compute tasks to be processed by at least one of the one or more communication processors.

36. The method of claim 35, wherein determining whether the excess processing budget is available to process the at least one of the one or more pending compute tasks comprises comparing the estimated processing load and determine whether the total processing budget is greater than the estimated processing load by a threshold amount, and
further comprising determining, by the compute device, the threshold amount based on an estimated amount of computation resources required to process the at least one of the one or more pending compute tasks.

37. The method of claim 35, wherein allocating the at least one of the one or more pending compute tasks comprises to one of (a) assigning a priority level to the at least one of the one or more pending compute tasks that is greater than communication tasks being processed by the one or more communication processors or (b) enqueuing the at least one of the one or more pending compute tasks into a task queue of the one or more communication processors.

38. The method of claim 35, further comprising:
identifying, by the compute device and in response to the determination that the excess processing budget is available to process the one or more pending compute tasks, a priority level of one or more communication quality of service requirements
comparing, by the compute device, the identified priority level of the one or more communication quality of service requirements against a priority level of the one or more pending compute tasks; and
reducing, by the compute device and in response to a determination that a result of the comparison indicates that the identified priority level of the one or more communication quality of service requirements is lower than a priority level of the one or more pending compute tasks, a communication data rate to free additional communication processor computation resources for processing the at least one of the one or more pending compute tasks.

39. The method of claim 35, further comprising monitoring, by the compute device, wireless communication modes at run-time, and wherein estimating the processing load comprises estimating the processing load as a function of the monitored wireless communication modes.

40. The method of claim 35, further comprising measuring, by the compute device, wireless channel conditions at run-time, and wherein estimating the processing load comprise estimating the processing load as a function of the measured wireless channel conditions.

41. The method of claim 35, further comprising:
receiving, by the compute device, an urgent communication task for processing by the one or more communication processors;
interrupting, by the compute device, the processing of the at least one of the one or more compute tasks by the one or more communication processors; and
reallocating the at least one of the one or more compute tasks to be processed by one or more compute processors of the compute device.

42. The method of claim 41, wherein reallocating the at least one of the one or more compute tasks comprises assigning a priority level to the at least one of the one or more compute tasks that is less than communication tasks being processed by the one or more communication processors.

43. One or more machine-readable storage media comprising a plurality of instructions stored thereon that, when executed, cause a compute device to:
identify, one or more pending communication tasks and one or more pending compute tasks;
estimate a processing load of the identified one or more communication tasks;
determine a total processing budget of one or more communication processors of the compute device based on computation resources of the one or more communication processors;
determine whether excess processing budget is available to process at least one of the one or more pending compute tasks; and
allocate, in response to a determination that the excess processing budget is available to process one or more pending compute tasks, at least one of the one or more pending compute tasks to be processed by at least one of the one or more communication processors.

44. The one or more machine-readable storage media of claim 43, wherein to determine whether the excess processing budget is available to process the at least one of the one or more pending compute tasks comprises to compare the estimated processing load and determine whether the total processing budget is greater than the estimated processing load by a threshold amount, and
wherein the plurality of instructions, when executed, further cause the compute device to determine the threshold amount based on an estimated amount of computation resources required to process the at least one of the one or more pending compute tasks.

45. The one or more machine-readable storage media of claim 43, wherein to allocate the at least one of the one or more pending compute tasks comprises to one of (a) assign a priority level to the at least one of the one or more pending compute tasks that is greater than communication tasks being processed by the one or more communication processors or (b) enqueue the at least one of the one or more pending compute tasks into a task queue of the one or more communication processors.

46. The one or more machine-readable storage media of claim 43, wherein the plurality of instructions, when executed, further cause the compute device to:
identify, in response to the determination that the excess processing budget is available to process the one or more pending compute tasks, a priority level of one or more communication quality of service requirements
compare the identified priority level of the one or more communication quality of service requirements against a priority level of the one or more pending compute tasks; and
reduce, in response to a determination that a result of the comparison indicates that the identified priority level of the one or more communication quality of service requirements is lower than a priority level of the one or more pending compute tasks, a communication data rate to free additional communication processor computation resources for processing the at least one of the one or more pending compute tasks.

47. The one or more machine-readable storage media of claim 43, wherein the plurality of instructions, when executed, further cause the compute device to monitor wireless communication modes at run-time, and wherein to estimate the processing load comprises to estimate the processing load as a function of the monitored wireless communication modes.

48. The one or more machine-readable storage media of claim 43, wherein the plurality of instructions, when executed, further cause the compute device to measure wireless channel conditions at run-time, and wherein to estimate the processing load comprise to estimate the processing load as a function of the measured wireless channel conditions.

49. The one or more machine-readable storage media of claim 43, wherein the plurality of instructions, when executed, further cause the compute device to:
receive an urgent communication task for processing by the one or more communication processors;
interrupt the processing of the at least one of the one or more compute tasks by the one or more communication processors; and
reallocate the at least one of the one or more compute tasks to be processed by one or more compute processors of the compute device.

50. The one or more machine-readable storage media of claim 41, wherein to reallocate the at least one of the one or more compute tasks comprises to assign a priority level to the at least one of the one or more compute tasks that is less than communication tasks being processed by the one or more communication processors.
